(19) United States
(12) Patent Application Publication
(10) Pub. No.: US 2022/0103543 A1
(43) Pub. Date: Mar. 31, 2022

(54) SECURE AUTHENTICATION METHOD FOR PERFORMING A HOST OPERATION USING A DELEGATED AUTHORIZATION MECHANISM

(71) Applicant: DELL PRODUCTS, LP, Round Rock, TX (US)

(72) Inventors: Rajib Saha, Bangalore (IN); Santosh Gore, Bangalore (IN); Bharath Koushik Suryanarayana, Bangalore (IN); Rishi Mukherjee, Bangalore (IN)

(21) Appl. No.: 17/032,780

(22) Filed: Sep. 25, 2020

(51) Int. Cl. H04L 29/06; H04L 29/12

(52) U.S. Cl. CPC H04L 63/0823; H04L 61/2557; H04L 63/20; H04L 63/105

(57) ABSTRACT

A method includes receiving a host operation request sent without a first credential that is associated with a first user, wherein the host operation request by a second user includes a second user credential, the second user is an administrator of a systems management application, and the first user has a privilege to perform the host operation request. The method also sends the host operation request to a host operating system agent to generate an authentication token, the host operation request includes a digital certificate associated with the management controller, and the authentication token based on the first user credential of the first user. The method may also receive the authentication token generated by the host operating system agent, and send a response to the host operation request of the second user, wherein the response includes the authentication token.

### FIELD OF THE DISCLOSURE

The present disclosure generally relates to information handling systems, and more particularly relates to a secure authentication method for performing a host operation using a delegated authorization mechanism.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A method includes receiving a host operation request sent without a first credential that is associated with a first user, wherein the host operation request by a second user includes a second user credential, the second user is an administrator of a systems management application, and the first user has a privilege to perform the host operation request. The method also sends the host operation request to a host operating system agent to generate an authentication token, the host operation request including a digital certificate associated with the management controller, and the authentication token based on the first user credential of the first user. The method may also receive the authentication token generated by the host operating system agent, and send a response to the host operation request of the second user, wherein the response includes the authentication token.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating an example of a system for a secure authentication method for updating a host operating system using a delegated authorization mechanism, according to an embodiment of the present disclosure;

FIG. 3 is a flowchart illustrating an example of a secure authentication method for performing a host operation using a delegated authorization mechanism, according to an embodiment of the present disclosure;

FIG. 4 is a flowchart illustrating an example of a method for installation or update of a host operating system agent, according to an embodiment of the present disclosure;

FIG. 5 is a flowchart illustrating an example of a secure authentication method for performing a host operation using a delegated authorization mechanism, according to an embodiment of the present disclosure; and

FIG. 6 is a flowchart illustrating an example of a method for secure authentication for performing a host operation using a delegated authorization mechanism, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

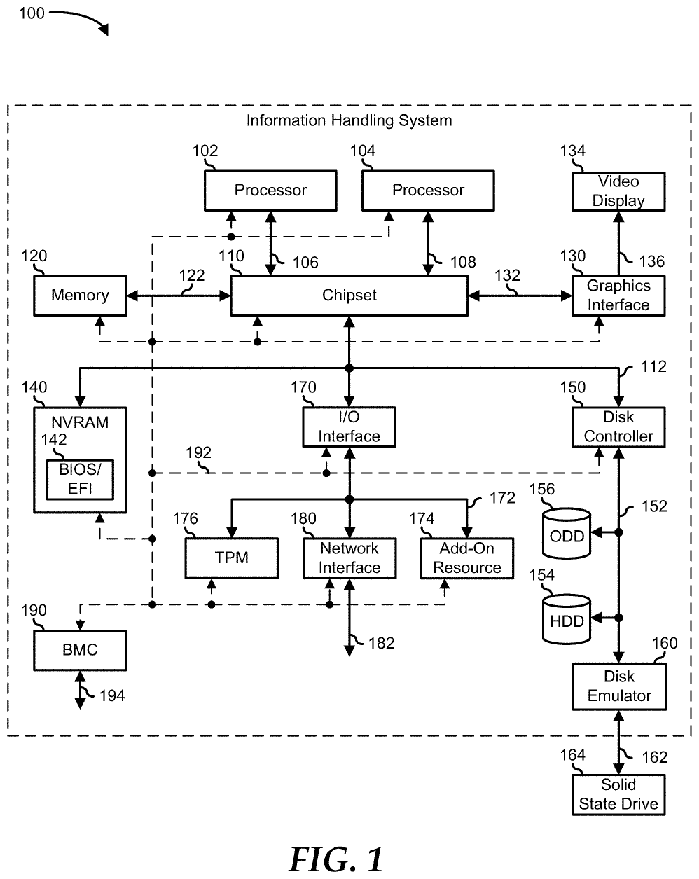

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a Peripheral Component Interconnect-Express (PCIe) interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor-defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple CPUs and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

An administrator typically uses a system management platform to monitor and manage information handling systems in virtual, physical, local, or remote environments. Generally, a system management credential and a host operating system credential are required to perform various functions in an information handling system such as to inventory and updates from a console associated with the system management platform. However, if a password associated with the operating system credential has changed or been forgotten by the administrator, then the administrator may not be able to perform the various functions as storing the operating system credential outside of the information handling system normally violates security protocols. Thus, it is desirable for a system and a method that allows the administrator to perform the aforementioned functions using the system management credential without knowing the host operating system credential.

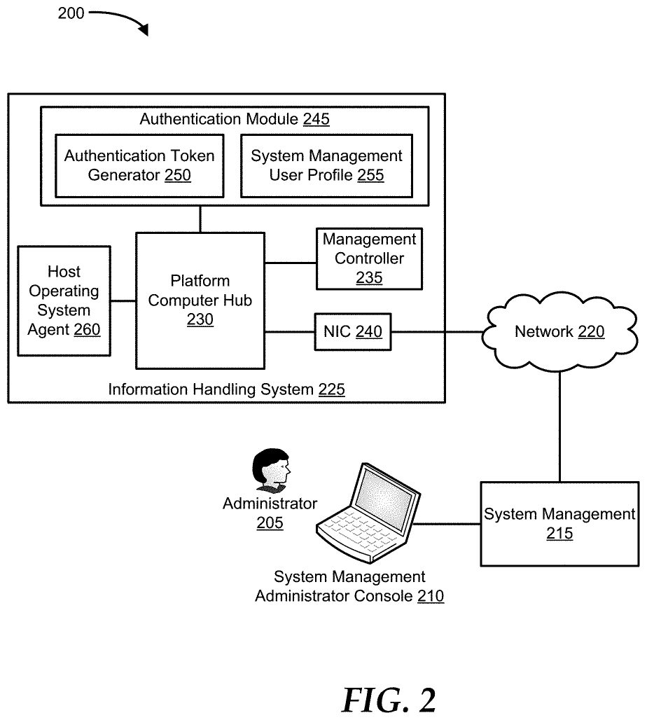

FIG. 2 shows an example of an environment 200 for secure authentication in performing an operation using a delegated authorization mechanism. Environment 200 includes a system management administrator console 210, a system management 215, a network 220, and an information handling system 225 that is similar to information handling system 100 of FIG. 1. Environment 200 supports token-based authentication to information handling system 225 from system manager 215 to support various operating system functions such as inventory and/or updates. In particular, environment 200 supports the token-based authentication from a host operating system interface. Environment 200 also supports the token-based authentication from a management controller interface.

A user such as administrator 205 may use system management administrator console 210 to remotely manage or configure information handling system 225. The user is intended to broadly construe as to encompass a human user associated with a given device or set of devices, an automated user such as an application or other hardware or software component associated with a given device, or any other entity that may control that device. Administrator 205 may send a request such as a host operation request to be performed on information handling system 225 to management controller 235 through system management administrator console 210 via OpenSSH. For example, administrator 205 may request an update operation such as firmware, software, or driver update. Administrator 205 may also send a request for information from information handling system 225. Administrator 205 may send a user credential or simply referred herein as a credential associated with system management 215 and/or management controller 235 with the host operation request. The OpenSSH protocol provides a secure channel from system management administrator console 210 to information handling system 225 over network 220. The OpenSSH protocol is an open-source version of Secure Shell (SSH) tools used by administrators for cross-platform management of remote systems.

System management administrator console 210 may include an interface, such as the host operating interface and the management controller interface that is associated with system management 215. System management 215 may be an out-of-band system management application suite such as Dell EMC OpenManage Enterprise for management console that provides management and control for a distributed computing environment, such as for large rack-mounted servers, blade service, data storage arrays, and other suitable devices via network 220. System management 215 may be configured to track device operation and configuration, generates management and administrator reports and performs other suitable functions as may be needed for control of the components of the distributed computing environment. System management 215 as directed by administrator 205 through system management administrator console 210 may initiate discovery of an update user account of information handling system 225 via its operating system.

Information handling system 225 includes a platform computer hub 230, a management controller 235, a network interface card (NIC) 240, a host operating system agent 260, and an authentication module 245 that includes an authentication token generator 250 and a system management user profile 255. System management 215 may be communicatively coupled to information handling system 225 and management controller 235 via platform computer hub 230 through NIC 240. Network 220 can be a local area network, a wide area network, a wireless network, a wireless network, or other suitable networks.

Management controller 235, which may similar to BMC 190 of FIG. 1, may be configured to delegate authentication and/or authorization process to host operating system agent 260. Management controller 235 may be configured to that generate an authentication token via authentication module 245. The authentication token may be time-bound and may be passed to system management 215 via management controller 235. System management 215 may use the authentication token to authenticate with information handling system 225 and perform the host operation request.

Host operating system agent 260, such as an iDRAC service module (iSM), is a software application installed on information handling system 225. Host operating system agent 260 uses IP socket communication and provides additional systems management data to management controller 235. Host operating system agent 260 may also be configured to generate the aforementioned authentication token.

Authentication module 245 may be configured to implement a policy to enable or disable authentication for host operating system user account. Authentication module 245 may be configured to authenticate a user and/or any entity that is requesting an operation to be performed with a component from information handling system 225 or requesting information from information handling system 225. In particular, authentication module 245 may validate the system management credential and/or the digital certificate of management controller 235 associated with the request to verify that the request is associated with an authorized user of system management 215 that is authorized to monitor and/or manage information handling system 225. Authentication module 245 may validate the credentials using a protocol such as OAuth 2.0 or security assertion markup language (SAML) that enables applications to obtain limited access to user accounts. Otherwise, if the user credentials are invalid, then an error may be generated, and the authentication request is terminated.

System management user profile 255 may include credentials with a system management user account also referred herein as an update user account. The update user account may be a host operating system user account that is configured to perform host operations or provide information requested such as an inventory of the components of information handling system 225. The update user account may be configured with credentials that allow time-based one-time password (TOTP) mechanism during an installation or an update of host operating system agent 260.

Authentication token generator 250 may be configured to generate an authentication token such as a TOTP token subject to validation of the system management credential and/or digital certificate of management controller 235 associated with the request. For example, management controller 235 may be used to share an update package for the update operation. Authentication token generator 250 may be configured to generate an authentication token such as a TOTP token based on a user profile such as the system management user profile 255. The authentication token is a single-use passcode for authenticating a user that may include a user credential that allows the user to perform the requested operation or receive the requested information. For example, the authentication token may allow the update user account to perform an update. In particular, the authentication token may be a string denoting a specific scope of access permitted with regards to protected resource for which the authentication token is valid, the length of time the authentication token is valid, the type of operating the authentication is valid, and/or other attributes.

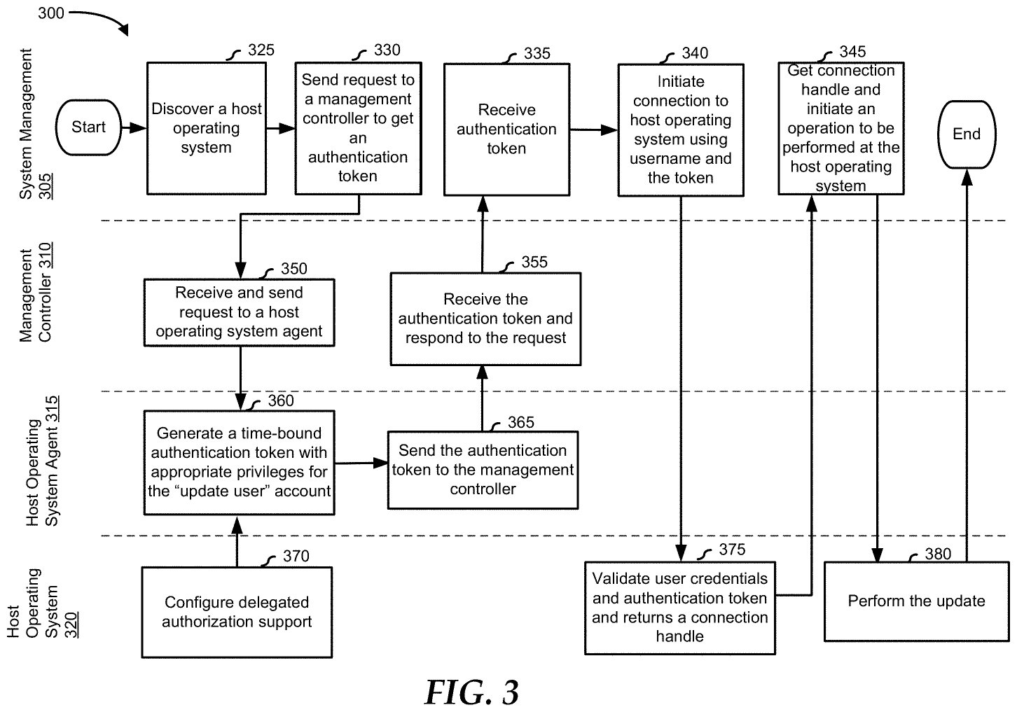

FIG. 3 shows a secure authentication method 300 for delegated authorization from the host operating interface at a system management remote console to support firmware and driver inventory and update. For example, method 300 may use OAuth token-based authentication from a system management application such as OpenManage Enterprise by Dell® to perform inventory or update of a client such as information handling system 225 of FIG. 2. The aforementioned may be performed by a system management administrator via the system management remote console without knowledge of the host operating system administrator's password.

Method 300 includes a systems management 305, a management controller 310, a host operating system agent 315, and a host operating system 320. Systems management 305 performs block 325, block 330, block 335, block 340, and block 345. Management controller 310 performs block 350 and block 355. Host operating system agent 315 performs block 360 and block 365. Host operating system 320 performs block 370, block 375, and block 380. While embodiments of the present disclosure are described in terms of environment 200 of FIG. 2, it should be recognized that other systems may be utilized to perform the described method.

Method 300 typically starts at block 325 where systems management 305 such as Dell EMC OMSA initiates a host operating system discovery via OpenSSH protocol. Method 300 proceeds to block 330 where the method sends a request for an authentication token, such as an OAuth token, to management controller 310. Management controller 310 may be configured to monitor and control the operation of host operating system 320. The request for an authentication token includes parameters for the connection such as a host operating system username, privilege, and application name. OAuth protocol is a standard that applications can use to provide client applications with secure delegated access. OAuth works over HTTP and authorizes devices, application programming interfaces (APIs), servers, and applications with access tokens. In one embodiment, the request can use the intelligent platform management interface (IPMI) standard.

Method 300 proceeds to block 350 where management controller 310 receives the request and sends the request to host operating system agent 315. Management controller 310 can communicate with host operating system agent 315 using the IPMI standard. Method 300 proceeds to block 360 where host operating system agent 315 generates an authentication token for the user. Before generating the authentication token, host operating system agent 315 may determine if the request for the authentication token is valid by comparing the received user or client credentials such as operating system username, privilege, and application name to a list of authorized users or clients. If the user or client credentials are a match to an entry within the list, the request for the authentication token is valid. Otherwise, the request is not valid. In response to determining that the request for the authentication token is not valid, host operating system agent 315 may generate a notification that the request is not valid and transmits a notification to management controller 310.

Prior to block 360, at block 370, host operating system 320 has been configured to support authentication tokens such as OAuth tokens on OpenSSH. Authentication tokens are credentials that can be used by a client to access services and resources. The authentication token includes appropriate privileges which inform the application that the bearer of the token has been authorized to access the application and perform specific functions. The authentication token is time-bound. As such, host operating system agent 315 may start a timer. When the timer expires, the authentication token is no longer valid. Method 300 proceeds to block 365 when host operating system agent 315 sends the authentication token to management controller 310.

Method 300 proceeds to block 355 where management controller 310 receives the authentication token and responds to the request received from system management 305. The response may include the authentication token. The response may also include connection information to host operating system 320. Method 300 proceeds to block 335 where systems management 305 receives the authentication token and proceeds to block 350 where a connection to host operating system 320 is initiated using the authentication token and user credentials of a user account with privileges to host operating system 320.

Method 300 proceeds to block 375 where the user credentials and the authentication token are validated by host operating system 320. If the user credentials and the authentication handle are valid, method 300 returns a connection handle. Method 300 proceeds to block 345 where systems management 305 gets the connection handle and initiates a host operation such as an update. Method 300 proceeds to block 380 where host operating system 320 performs the operation. After performing the operation, the method ends.

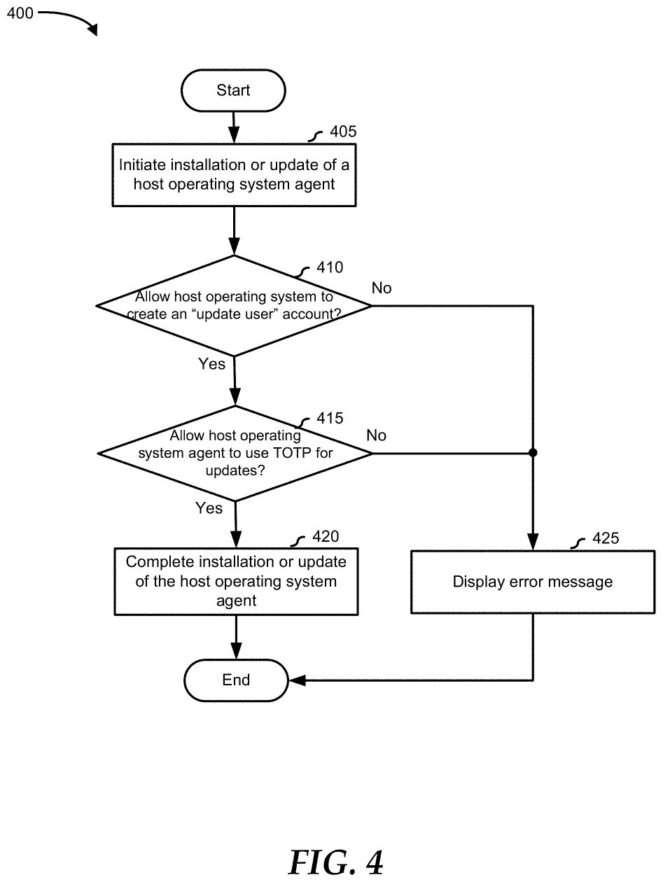

FIG. 4 shows a method 400 for installation or update of a host operating system agent. While embodiments of the present disclosure are described in terms of environment 200 of FIG. 2, it should be recognized that other systems may be utilized to perform the described method. Method 400 typically starts at block 405 where an administrator initiates installation or update of the host operating system agent. Method 400 proceeds to decision block 410, where the method may present a user interface to the administrator to facilitate entry on whether to allow the host operating system agent to create an “update user” account on the host operating system. The update user account is a user account that is allowed to perform an operation to the host operating system or its components such as perform an inventory of the components of the information handling system or perform an update. If the administrator allows the host operating system agent to create the update user account on the host operating system, then the “YES” branch is taken, and the method proceeds to decision block 415. If the administrator does not allow the host operating system agent to create the update user account on the host operating system, then the “NO” branch is taken, and the method proceeds to block 425.

At decision block 415, the method may present a user interface to the administrator to facilitate entry on whether to allow the host operating system agent to generate a TOTP token for host operations. If the administrator allows the host operating system agent to generate the TOTP token, then the “YES” branch is taken, and the method proceeds to block 420. If the administrator does not allow the host operating system agent to generate the TOTP token, then the “NO” branch is taken, and the method proceeds to block 425. At block 420, the method sends an acknowledgment (ACK) signal to signify receipt of the request and completes the installation of the host operating system agent. The method ends.

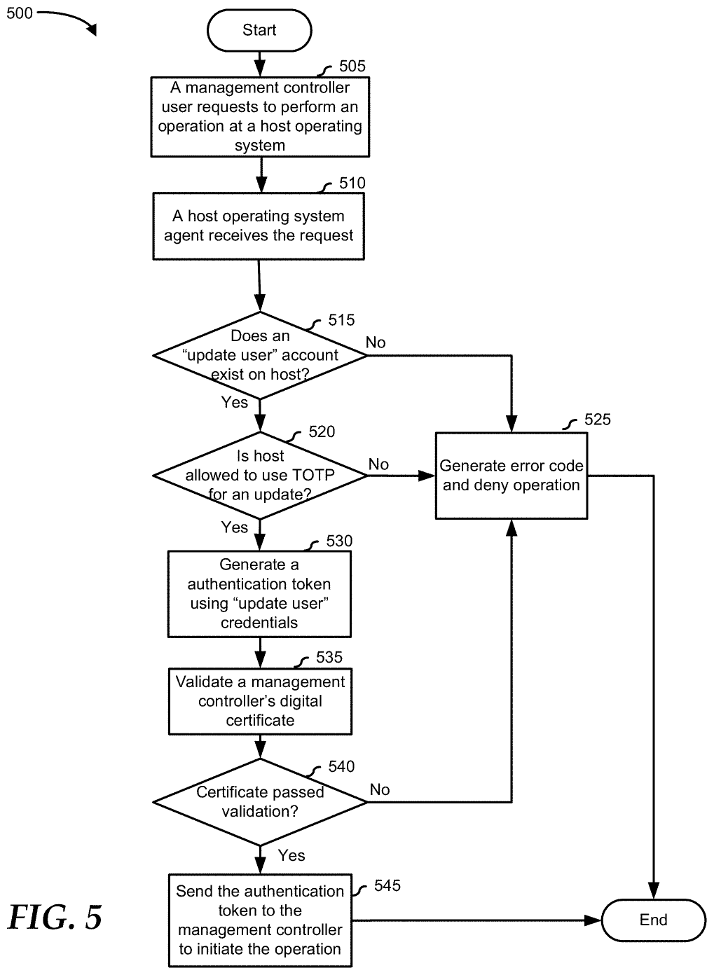

FIG. 5 shows a method 500 for secure authentication in performing an operation using a delegated authorization mechanism. While embodiments of the present disclosure are described in terms of environment 200 of FIG. 2, it should be recognized that other systems may be utilized to perform the described method. Method 500 typically starts at block 505 where a user of a systems management application suite sends a request to perform an operation at an information handling system also referred to as a host via a management controller interface of the systems management application suite console.

The method proceeds to block 510, where a host operating system agent receives the request. The method proceeds to decision block 515 where the host operating system agent determines whether an “update user” account exists on the host. If the update user account exists on the host, then the “YES” branch is taken, and the method proceeds to decision block 520. If the update user account does not exist on the host, then the “NO” branch is taken, and the method proceeds to block 525. At decision block 520, where the method determines whether the operating system agent is allowed to generate a TOTP token also referred herein as an authentication token. If the host operating system agent is allowed to generate the authentication token, then the “YES” branch is taken, and the method proceeds to block 530. If the host operating system agent is not allowed to generate the authentication token, then the “NO” branch is taken, and the method proceeds to block 525.

At block 525, the method generates an error code and denies the update request. At block 530, the method generates the authentication token using the user credentials of the update user account. The user credentials or simply credentials can include information that identifies a user account, a user, a group of users, a user classification, etc. For example, the user credentials can include a username, a password, an email address, a phone number, an account identifier, biometric data, clearance level position, location, etc. Biometric data includes fingerprint, voice print, iris or facial scan, etc.

The method proceeds to block 535 where the method verifies the certificate of the management controller that was sent with the update request. The method proceeds to decision block 540 where the method determines whether the certificate is authentic and valid. If the method determines that the certificate is authentic and valid, then the “YES” branch is taken, and the method proceeds to block 545. If the method determines that the certificate is not authentic or not valid, then the “NO” branch is taken, and the method proceeds to block 525. At block 545, the method sends the authentication token to the management controller to initiate the operation using the authentication token. In another embodiment, the method may verify the certificate of the management controller prior to block 530.

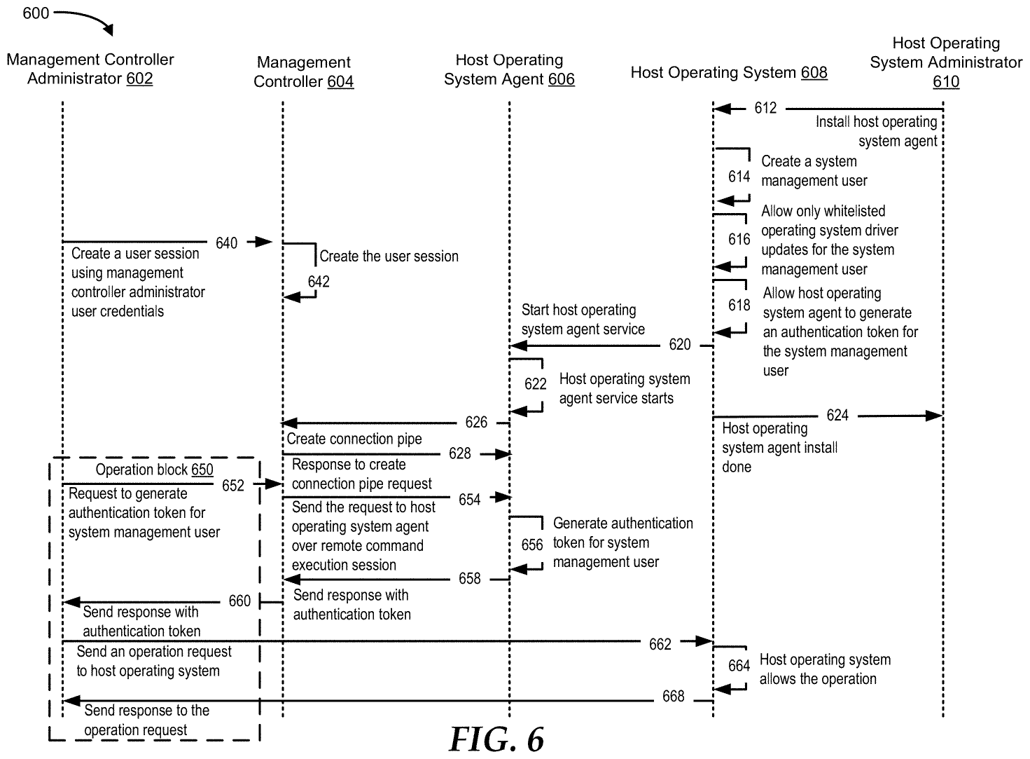

FIG. 6 shows a flowchart 600 for a secure authentication method for delegated authorization from an interface of a management controller also referred herein as a BMC or a service processor. The interface may be located at a system management remote console. The interface may support inventory of the information handling system and a firmware or a driver update. For example, method 600 may use OAuth token-based authentication from a system management application suite to perform an operation at the information handling system. The operation may include an inventory, or an update of a client also referred to as a host such as information handling system 225 of FIG. 2. The operation may be performed without credentials of the system management user included in the operation request from the system management remote console.

The flowchart includes a management controller administrator 602, a management controller 604, a host operating system agent 606, a host operating system 608, and a host operating system administrator 610. While embodiments of the present disclosure are described in terms of environment 200 of FIG. 2, it should be recognized that other systems may be utilized to perform the described method. Method 600 typically starts at step 612 where host operating system administrator 610 installs and/or updates a host operating system agent such as host operating system agent 606. At step 614, the host operating system administrator creates a system management user account also referred to as an update user account. The creation of a system management user account is a one-time account creation. The system management user is authorized to perform an operation at host operating system 608.

At step 616, host operating system administrator 610 gives a user privilege to perform whitelisted operations at host operating system 608 such as inventory and firmware or driver updates. At step 618, host operating system administrator 610 allows host operating system agent 606 to generate an authentication token using the media access control (MAC) address associated with a NIC of the information handling system. At step 620, host operating system 608 sends a request to start host operating system agent 606 service. At step 622, host operating system agent 606 service starts. After host operating system agent 606 successfully starts, host operating system agent 606 installation or update is complete at step 624. At step 626, host operating system agent 606 sends an access request via a connection pipe to management controller 604 over USB to NIC. The access request may include user credentials such as username, domain name, and password. After validating the request, management controller 604 sends a response to host operating system agent 606 granting access via the connection pipe at step 628.

At step 640, management controller administrator 602 sends a create session request to management controller 604 using management controller 604 credentials. In one example, management controller administrator 602 may have forgotten or do not know the host operating system administrator password. Management controller administrator 602 may request a session to perform an operation at host operating system 60 such as a firmware or driver update as depicted in operation block 650. At step 642, after validating the credentials submitted by management controller administrator 602, management controller 604 creates a user session. For example, management controller 604 validates that management controller administrator 602 is an administrator on management controller 604.

Operation block 650 includes step 652, step 660, step 662, and step 668. Before performing the update at host operating system 608, the credentials of management controller administrator 602 may be validated. Management controller administrator 602 may request an operation to be performed at host operating system 608. The request may be transmitted without sending user credentials associated with a user with a privilege to perform the requested operation. For the operation request to be performed, an authentication token that includes user credentials associated with the user with the privilege may be needed.

At step 652, management controller administrator 602 sends a request for an authentication token to management controller 604. In particular, management controller administrator 602 may request for a TOTP token associated with system management user. The request may be sent to host operating system agent 606 via management controller 604. Management controller administrator 602 may send user credentials such as username and password associated with system management user with the request. In addition, the request may include a digital certificate associated with management controller 604.

At step 654, management controller 604 sends the request to host operating system agent 606 over operating system-management controller pass-through. The pass-through provides bi-directional in-band communication between management controller 604 and host operating system 608. The pass-through may be provided through a shared LAN on motherboard (LOM), a dedicated NIC, or through the USB NIC. Management controller 604 may send the request over a remote command execution (RCE) via the USB NIC connection pipe.

At step 656, host operating system agent 606 may generate an authentication token for the system management user. Host operating system agent 606 may use the operating system credentials of system management user created during the installation and/or update of host operating system agent 606. In particular, host operating system agent 606 may validate the request and user credentials prior to generating the authentication token for the system management user. In addition, host operating system agent 606 may validate the certificate of management controller 604 that was submitted with the request. The certificate may be signed by the manufacturer of management controller 604 or a trusted third-party public key infrastructure (PKI) certificate authority (CA).

After the validation of the user credentials and/or the certificate, then the process may proceed to step 658. Otherwise, an error code is generated, and the operation is denied. Management controller 604 may have a network address translation (NAT) rule to forward a packet it receives from a console to the host operating system 608 via USB NIC. This enables management controller 604 to be abstracted from operations on host operating system 608. This NAT rule will be disabled after the update package is successfully received by host operating system 608.

At step 658, host operating system agent 606 may send a response with the authentication token to management controller 604. Management controller 604 may then send the authentication token to management controller administrator 602 at step 660. At step 662, management controller administrator 602 may send the host operation request or simply operation request such as an update to host operating system 608. The operation request may include user credentials for system management user, the authentication token, and the update package. Upon receipt of the request, host operating system 608 may validate the user credentials, the authentication token, and the update package before proceeding to step 664 where host operating system 608 allows the operation. At step 668, host operating system 608 sends a response to allow the operation request to management controller administrator 602. Upon receipt of the response, management controller administrator 602 may perform the operation. The flowchart ends.

Although FIG. 3, FIG. 4, FIG. 5, and FIG. 6 show example blocks of method 300, method 400, method 500, and method 600 in some implementation, method 300, method 400, method 500, and method 400 may include additional blocks, fewer blocks, different blocks, or differently arranged blocks than those depicted in FIG. 3, FIG. 4, FIG. 5, and FIG. 6. Additionally, or alternatively, two or more of the blocks of method 300 and method 400 may be performed in parallel. For example, step 640 and step 620 of method 600 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a management controller, a host operation request at an information handling system, wherein the host operation request is sent without a first user credential that is associated with a first user, wherein the host operation request by a second user includes a second user credential, wherein the second user is an administrator of a systems management application that manages the information handling system, and wherein the first user has a privilege to perform the host operation request at the information handling system;
sending the host operation request to a host operating system agent of the information handling system to generate an authentication token, wherein the host operation request includes a digital certificate associated with the management controller, and wherein the authentication token is based on the first user credential of the first user;
receiving the authentication token generated by the host operating system agent subsequent to an authentication of the digital certificate by the host operating system agent; and
sending a response to the host operation request of the second user, wherein the response includes the authentication token.

2. The method of claim 1, wherein the host operation request is sent from a host operating system console interface of the systems management application through a remote client device.

3. The method of claim 1, further comprising determining whether the first user is configured on the information handling system.

4. The method of claim 1, further comprising determining whether the host operating system agent is allowed to generate the authentication token.

5. The method of claim 1, wherein the authentication token is generated subsequent to authentication of the second user credential.

6. The method of claim 1, wherein the host operation request is to perform a device inventory of the information handling system.

7. The method of claim 1, wherein the host operation request is to perform an update of a component of the information handling system.

8. The method of claim 1, wherein the authentication token may be used to authenticate the host operation request by the information handling system.

9. The method of claim 1, wherein the first user is configured prior to the receiving the host operation request.

10. The method of claim 1, wherein the first user is allowed to perform the host operation request in the information handling system.

11. The method of claim 1, wherein the host operating system agent is configured to generate the authentication token for the first user.

12. The method of claim 1, wherein the first user is configured during an installation or an update of the host operating system agent.

13. An information handling system, comprising:
a host operating system agent configured to:
generate an authentication token for a first user subsequent to an authentication of a digital certificate associated with a service processor; and
send the authentication token to the service processor;
the service processor configured to:
receive a host operation request for the information handling system from a second user, wherein the host operation request is sent without a first user credential that is associated with the first user;
send the host operation request to the host operating system agent for the authentication of the digital certificate that is included with the host operation request, wherein the digital certificate is associated with the service processor, and wherein the authentication token is associated with the first user credential;
receive the authentication token from the host operating system agent subsequent to the authentication of the digital certificate associated with the service processor; and
send a response to the host operation request with the authentication token to the second user.

14. The information handling system of claim 13, wherein the host operation request is sent from a service processor console interface of a systems management application through a remote client device.

15. The information handling system of claim 13, wherein the host operation request is associated with a second user credential that is associated with the service processor.

16. The information handling system of claim 15, wherein the service processor is further configured to validate whether the second user is an administrator of the service processor.

17. The information handling system of claim 15, wherein the service processor is further configured with a network address translation rule that is used to send the host operation request to the host operating system agent.

18. The information handling system of claim 17, wherein the network address translation rule is disabled after an update package associated with the host operation request is received.

19. A non-transitory computer-readable medium including code that when executed performs a method, the method comprising:
receiving a host operation request for an information handling system, wherein the host operation request is sent without a host operating system user credential, wherein the host operation request is sent from a user from a system management application monitoring the information handling system, and the host operation request includes user credentials associated with the system management application;
sending the host operation request to a host operating system agent for authentication, wherein the host operation request includes a digital certificate associated with a service processor, and wherein the authentication is based on the host operating system user credential preconfigured for performing the host operation request;
receiving an authentication token from the host operating system agent subsequent to the authentication of the digital certificate; and
sending the authentication token to the user.

20. The method of claim 19, wherein the sending the host operation request to the host operating system agent is performed over a host operating system and service processor pass-through.
